(19) United States
(12) Patent Application Publication
(10) Pub. No.: US 2011/0068622 A1
(43) Pub. Date: Mar. 24, 2011

(54) VEHICLE HIGH VOLTAGE CABLE LAYOUT STRUCTURE

(75) Inventors: Masayuki Ikeno, Shizuoka-ken (JP); Junka Iwasaki, Shizuoka-ken (JP)

(73) Assignee: SUZUKI MOTOR CORPORATION, Hamamatsu-shi (JP)

(21) Appl. No.: 12/875,431

(22) Filed: Sep. 3, 2010

(30) Foreign Application Priority Data
Sep. 24, 2009 (JP) 2009-218937

(51) Int. Cl. B60L 1/00

(52) U.S. Cl. 307/10.1

(57) ABSTRACT

In a layout structure for a high voltage cable of an electric vehicle, the high voltage cable running from front to back is arranged to be kept towards the center of the vehicle, thereby avoiding damage to the cable even in the event of side impact. The high voltage cable (32) is arranged at a position over a rear floor panel (21) where it vertically overlaps with the fuel tank (26) running centrally in the vehicle width direction (Y) so as to lie along a front/rear center axis (1C) of the vehicle (1). The cable is arranged in such a manner that ahead of the position where the cable overlaps the fuel tank (26), the cable enters an area corresponding to the passenger compartment (4) upon leaving a standard surface of the rear floor panel (21), after which the cable runs towards the front of the vehicle in a region below the standard surface of a front floor panel (20) corresponding to the passenger compartment (4).

### FIELD OF THE INVENTION

The invention relates to a layout structure for a high voltage cable of a vehicle. More particularly, in a high voltage energy system which is installed in an electric vehicle (EV) in a broad sense including a hybrid electric vehicle (HEV), a fuel-cell electric vehicle (FCHEV), and the like, the invention relates to a layout structure for a high voltage cable of a vehicle, which is used for coupling a battery and a generator/drive motor or an inverter.

### BACKGROUND OF THE INVENTION

In an electric vehicle (EV) (hereinbelow, referred to by the term “vehicle”) in a broad sense including a hybrid electric vehicle (HEV), a fuel-cell electric vehicle (FCHEV), and the like, as illustrated in FIG. 6, both of a battery (cell) 125 and a fuel tank 126 are attached in a rear portion of a vehicle 101. The battery 125 is arranged at the vehicle rear side of the fuel tank 126 and over a rear floor panel of a luggage compartment 105. A high voltage cable 132 is arranged so as to be connected to the battery 125 and to be extended toward a vehicle front portion.

In this case, in a layout of the high voltage cable 132 for coupling an inverter 131 arranged in an engine compartment 103 with the battery 125 behind a rear seat 127, since the fuel tank 126 is present, the cable 132 is arranged in such a manner that at a position near a front portion of the fuel tank 126, the cable is temporarily led towards the outside of the vehicle (outside-car route: R2) and, thereafter, penetrates a grommet 137, and is arranged in an area corresponding to the passenger compartment 104 (inside-car route: R1).

In a piping structure for a battery for a vehicle according to assignee's Japanese published patent application No. 2004-148850, an exhaust hose is held by holding means along a power line and the exhaust hose and the power line are integrated and extended from a through-hole to the outside of the passenger compartment.

Examined Japanese patent application No. 3838505 discloses an arranging structure of a power line of a vehicle in which the power line for communicating a motor for running and a battery is arranged along a side member without being curved with a small curvature.

### PROBLEM TO BE SOLVED BY THE INVENTION

In the layout structure of the high voltage cable of a vehicle according to FIG. 6, hitherto, since the high voltage cable 132 passes through the outside of the vehicle as illustrated in FIG. 7, in the presence of an external lateral force, there is a danger of the high voltage cable 132 being damaged by vehicle body deformation P.

Since the high voltage cable 132 passes through a region near the fuel tank 126, there is a danger of the high voltage cable 132 coming into contact with the fuel tank 126 due to the vehicle body deformation P when the external force acts and the high voltage cable 132 becoming damaged, and there is a need to improve this arrangement.

In the related art, performance of the electric vehicle depends largely on advancement in battery development. It is necessary for a battery (pack) of high electric capacity and large volume and weight to be mounted in many electric vehicles (EV) in order to guarantee a long cruising distance.

There is a tendency for the battery assembly to grow in size irrespective of size of vehicle in order to achieve vehicle performance (for example, cruising distance over which the vehicle can run continuously per battery charge) comparable to that of gasoline and diesel engine powered vehicles.

In the electric vehicle (EV), in order to mount such a large battery, initially, a vehicle in which a space between the ground and the floor panel of the vehicle body is large is taken as a basis. In the case where the fuel tank is attached under a rear portion of the vehicle, the battery is mounted under the floor panel in front of the fuel tank, or over the floor panel over the fuel tank. By mounting the battery at such a position, in the case of a large vehicle, the battery, constituting a heavy object, can be attached near the center of the vehicle. Thus, the benefits of not only high running stability and excellent ride comfort for the vehicle can be secured but also product performance of the vehicle can be assured in terms of usability without reducing space for the luggage compartment at the rear of the vehicle.

The high voltage energy system can be concentrated on the region under the floor panel near the vehicle center to a certain extent and, since an area where the high voltage cable is arranged is also narrow, the high voltage energy system can be easily protected against external forces from the front, rear, right, and left of the vehicle. There is consequently an advantage in that the number of limitations which should be taken into consideration can be reduced.

However, either a choice has to be made between adopting a basic vehicle which is limited to a relatively large vehicle, or being obliged to provide a vehicle having a dedicated body design. In both cases, a disadvantage is encountered in that it is difficult to provide a vehicle at a low price as a small compact vehicle.

In use in an urban area involving a large number of starting/stopping operations of the vehicle due to traffic jams or the like, the number of passengers is small, and trip distance per run is short, this contradictory situation leads it to be considered that, from a viewpoint of fuel economy, the compact small vehicle is the better vehicle.

As an example where such a system is installed in a compact small vehicle, we have for instance, assignee's Japanese published patent application No. 2004-148850 mentioned above, or similar cases. This fundamentally relates to a hybrid vehicle converted in such a manner that an electric generator, a battery, and the like are added to a gasoline-powered vehicle in which an engine is used as a power unit, thereby enabling drive assistance and regenerative power generation to be performed.

Although the vehicle according to assignee's Japanese published patent application No. 2004-148850 cannot be regarded as an electric vehicle because it cannot run only using the motor, it is a hybrid vehicle. The high voltage energy system including the battery, generator/drive motor, inverter, and high voltage cable, the engine, and the fuel tank are mounted in such a vehicle.

Although there is very little change to the vehicle body by way of a converted car, when we look at the high voltage cable, in the area between the battery and inverter mounted in the rear portion of the vehicle and the engine in the vehicle front portion, the cable is arranged so as to be exposed to the outside in the regions under the fuel tank and under the floor panel.

Particularly, regarding the layout of the high voltage cable which passes through the area where the fuel tank is attached, although it is located at the center in the vehicle width direction, the cable is arranged so as to pass through the region under the fuel tank. But in view of the small size of the vehicle corresponding to a commuter car with extremely short front to back dimensions, although such a layout is a rectilinear simple arrangement, performance is commensurate with safety.

When constructing an electric vehicle (EV) taking a compact small vehicle as a basis, in a region near the vehicle center, there is an emphasis on providing the space required to ensure adequate passenger space and ensuring comfort. Therefore, in order to mount the large battery, additional factors such as carrying capacity and convenience of the luggage compartment or the like are sacrificed and the battery of which both electrical storage capacity and volume/weight are high is mounted at the rear portion of the vehicle.

In the case where the electric vehicle (EV) is a hybrid vehicle in which a fuel tank for a fuel having high volatility (particularly, liquid fuel such as gasoline, diesel fuel, alcohol-blended fuel, or the like), a system for supplying its power unit and the like have been mounted, it is essential to pay sufficient attention to the relation between these fuels and electricity. Particularly, it is necessary to make an effort to assure safety under ordinary conditions of use so as not to encourage mutual influence between them and provoke severe combustion.

In the case where both the battery having high electrical storage capacity and volume/weight as well as the fuel tank are mounted towards the rear of the vehicle, even in a case where the vehicle is damaged by an external force, it is necessary to avoid mutual influence between the fuel and the electricity. That is to say the electricity should be isolated from the fuel and the possibility of short-circuiting be reduced as much as possible.

In assignee's foregoing Japanese published patent application No. 2004-148850 or similar cases, since the inverter is also enclosed in the luggage compartment, even if current flow is considered, it is desirable that the cable does not pass through the inside of the area corresponding to the passenger compartment, and it can be considered that even with a layout in which the cable passes out of the vehicle, then, by providing a protective member, necessary performance can be assured to prevent damage to the cable. Nevertheless, it is desirable to make use of a structure adapted to further improve protective performance.

Moreover, if the battery has been equipped with a charger for charging it, since a considerable amount of heat is generated during charging using the charger, a device for cooling is necessary.

### SUMMARY OF THE INVENTION

It is, therefore, an object of the invention to provide a layout structure for a high voltage cable of a vehicle, in which even in the case where the vehicle is damaged to an extent where it suffers considerable deformation as a result of an external force, a resulting influence on the high voltage cable is avoided as much as possible, mutual influence between fuel and electricity is avoided, the number of installation parts for protecting the high voltage cable and the like is kept to a minimum, and a charger to charge the battery is provided with a structure for controlling its temperature, by the use of an appropriate layout structure for the high voltage cable connected to the battery.

According to the invention, there is provided a layout structure for a high voltage cable of a vehicle in which a battery and a fuel tank are mounted in a vehicle rear portion, the battery is arranged at a vehicle rear side of the fuel tank and over a rear floor panel, and the high voltage cable is arranged so as to be connected to the battery and to be extended toward a vehicle front portion,

wherein the high voltage cable is arranged at a position over the rear floor panel where it vertically overlaps with the fuel tank at a central portion thereof in a vehicle width direction so as to lie substantially along a front/rear center axis of the vehicle and is arranged in such a manner that ahead of the position where the cable overlaps the fuel tank, the cable enters an area corresponding to a passenger compartment leaving a standard surface of the rear floor panel, and in front thereof, the cable passes through a region below a standard surface of a front floor panel.

According to this layout structure for the high voltage cable of the vehicle of the invention, the high voltage cable is arranged substantially at the vehicle center and damage to the high voltage cable can be avoided even if the vehicle body is subject to deformation under the action of an external force.

### BRIEF DESCRIPTION OF THE DRAWINGS

FIG. 1 is a schematic constructional diagram of a vehicle in which a high voltage cable is arranged.

FIG. 2 is a plan view of the vehicle.

FIG. 3 is a perspective view looking into an area corresponding to the passenger compartment of the vehicle when seen from above.

FIG. 4 is a bottom view of a front floor panel of the vehicle seen from below.

FIG. 5 is a perspective view of a rear portion of the vehicle seen from above.

FIG. 6 is a schematic constructional diagram of a vehicle in which a high voltage cable is arranged according to the prior art.

FIG. 7 is an explanatory diagram illustrating a state where an external force has acted from the side and the vehicle body has undergone deformation with the prior art high voltage cable arrangement in a vehicle.

### DETAILED DESCRIPTION OF A PREFERRED EMBODIMENT

According to the invention, the aim of avoiding damaging a high voltage cable even when vehicle body deformation has occurred under the effect of an external force is accomplished by arranging the high voltage cable to run substantially at the center of the vehicle.

An embodiment of the invention will be specifically described in detail hereinbelow with reference to the drawings.

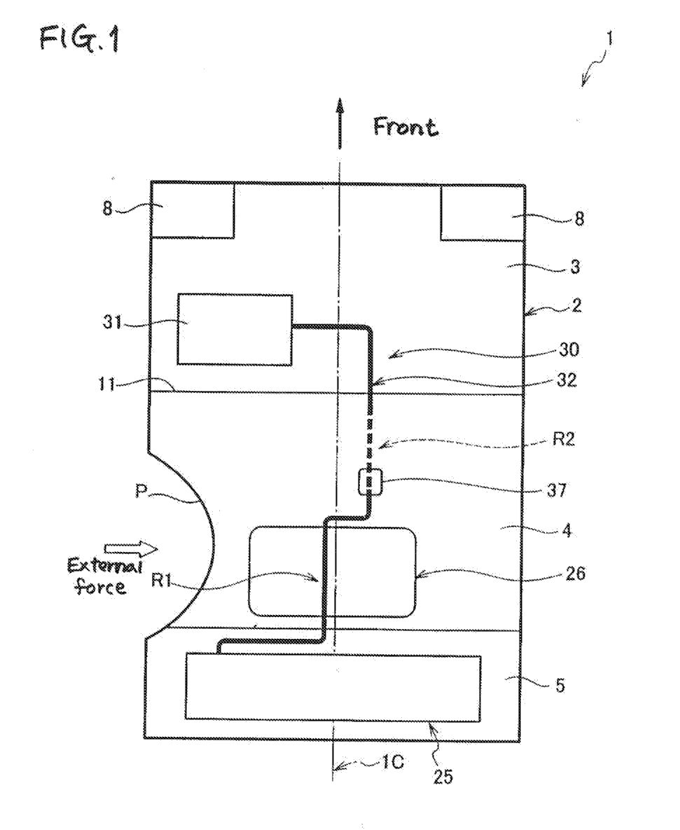

FIGS. 1 to 5 illustrate an embodiment of the invention.

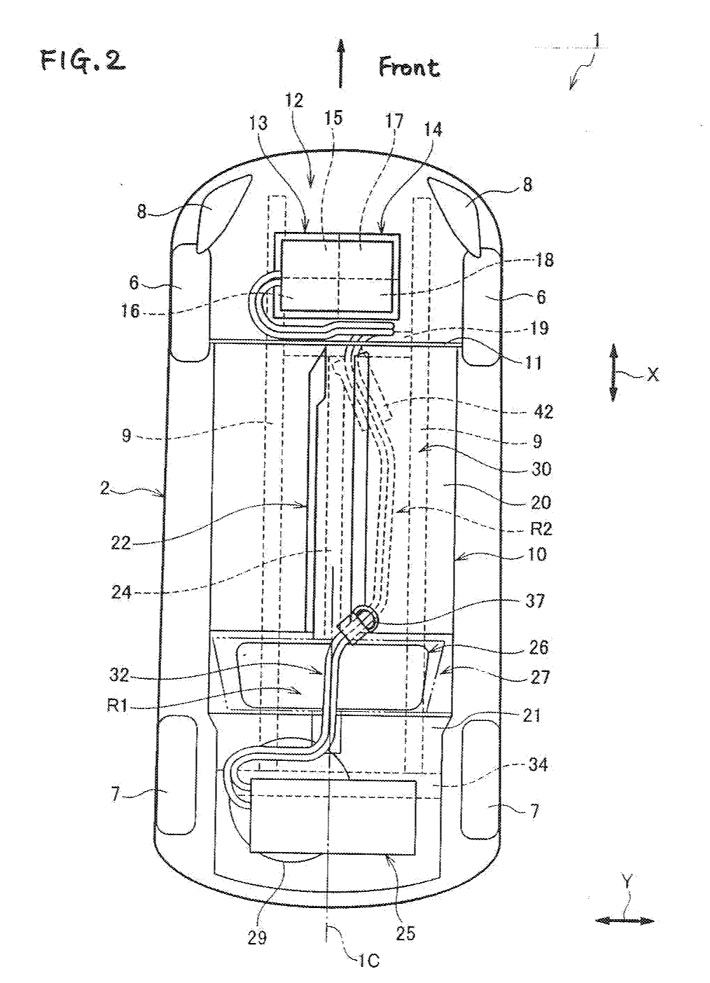

In FIGS. 1 and 2, reference numeral 1 denotes an electric vehicle (EV) (hereinbelow, referred to as the “vehicle”) in a broad sense covering a hybrid electric vehicle (HEV), a fuel-cell electric vehicle (FCHEV), and the like; 2 a vehicle body; 3 an engine compartment of a vehicle front portion; 4 an area corresponding to the passenger compartment in the central portion of the vehicle; 5 a luggage compartment at a vehicle rear portion; 6 front wheels; 7 rear wheels; 8 headlights; 9 side frames; 10 a floor panel of the vehicle 2; and 11 a dash panel.

An engine generator unit 13 and a drive motor gear casing unit 14 making up an on-vehicle unit (engine ASSY) 12 are arranged in the engine compartment 3.

Apparatuses such as a radiator of a cooling system for the internal combustion engine, a radiator of a cooling system for the generator/drive motor, capacity for an air conditioning system, and the like are arranged in a front portion of the engine compartment 3. Apparatus such as an electric compressor for the air conditioning system, a water pump of the cooling system for the generator/drive motor, and the like are arranged in a lower portion of the engine compartment 3. In the foregoing cooling system for the generator/drive motor, a generator 16, a drive motor 17, and an inverter 31, which will be described hereinafter, are respectively cooled.

The engine generator unit 13 is made up by integrating: an engine 15 starting and stopping of which can be switched at any time while the vehicle 1 is running and a generator 16 mechanically coupled with the engine 15. The engine generator unit 13 does not generate direct vehicle propulsion but generates electrical power for powering the drive motor gear casing unit 14. That is, the vehicle 1 is based on a series type hybrid driving system. If the engine generator unit 13 is omitted, the vehicle 1 is an electric vehicle in a narrow sense.

When a specific condition in which the amount of charge in the battery 25, which will be described hereinafter, has decreased or similar situation is satisfied, the engine generator unit 13 starts up and drives the engine 15 and rotates the generator 16 so as to perform power generation. A longitudinal direction of the unit 13 is oriented in the vehicle width direction and in both of the right and left edge portions, the unit 13 is fixed to the side frames 9 of the vehicle 2 through mounts. The crankshaft height of the engine 15 and the height of the rotational axis of the generator 16 are lower than the height of the rotational axis of the drive motor 17, which will be described hereinafter, thereby contributing to keeping center of gravity low.

The drive motor gear casing unit 14 is a true unit for propelling the vehicle 1. In order to generate vehicle propulsion and propagate driving power, the unit 14 is made up by integrating: the drive motor 17 for generating the vehicle propulsion; and a gear casing 18 for propagating motive power in association with the drive motor 17.

The drive motor gear casing unit 14 is fixed to an upper surface side of a subframe (suspension frame) 19 of the vehicle body 2 through a rear mount adapted to isolate vibration by an elastic member. The unit 14 propagates the driving power from the gear casing 18 to driveshaft means. Alternatively, the unit 14 can propagate the driving power through an intermediate axle if necessary with regard to balance, vibration, and the like to right and left driving wheels.

The gear casing 18 has, in its upper portion, an input shaft which is coaxial with the rotational axis of the drive motor 17 and has, in its lower portion, an output shaft coupled to driveshaft means. A reduction gear and a differential gear are enclosed in the gear casing 18. The external shape of the gear casing 18 can be formed in such a manner that it is relatively long in a vertical direction and is short in a vehicle front/rear direction. The intermediate shaft is arranged under the drive motor 17.

The engine generator unit 13 and the drive motor gear casing unit 14 are coupled so as to be mechanically integrated at the parts thereof which are closest together and, thereafter, mounted onto the vehicle body 2 through three mounts (right and left mounts and a rear mount). Ordinarily, they are stably supported by the three mounts and, in the presence of a load resulting from an external force from the front, the on-vehicle unit 12 in which the engine generator unit 13 and the drive motor gear casing unit 14 have been integrated can shift almost horizontally toward the rear of the vehicle.

The rotational axis of the drive motor 17 is arranged at a position higher than the crankshaft of the engine 15 and the rotational axis of the generator 16. Thus, the casing of generator 16 and the casing of drive motor 17 are arranged so that a part of them overlaps in the vertical direction when seen in plan view (or when seen from the lower surface), thereby reducing the length of on-vehicle unit 12 in a vehicle front/rear direction X. At the same time, large dimensions for movement can be assured for the mounting space in vehicle body 2. Particularly, dimensions between the dash panel 11 and the casing of the drive motor 17 are assured.

The floor panel 10 of the vehicle body 2 is made up by a front floor panel 20 at the vehicle front portion and a rear floor panel 21 at the vehicle rear portion. A standard surface of the rear floor panel 21 is set so as to be higher than a standard surface of the front floor panel 20. A central tunnel 22 is formed in the front floor panel 20 in a central portion in the vehicle width direction Y so as to be oriented in the vehicle front/rear direction, and a steering wheel attaching portion 23 is formed in the front portion.

An exhaust pipe 24 making up an exhaust system of the engine 15 passes through a region under the engine 15, forms a two-stage crank-shaped bent portion, passes through an internal space of the central tunnel 22 of front floor panel 20, and is extended toward the vehicle rear portion. The two-stage crank-shaped bent portion of exhaust pipe 24 provides a surround shape in order to bypass the gear casing 18 thereby increasing the distance from the engine 15, and reducing the influence of heat radiation.

In the vehicle rear portion, both the battery (pack) 25 and fuel tank 26 are mounted in the luggage compartment 5 located over the rear floor panel 21.

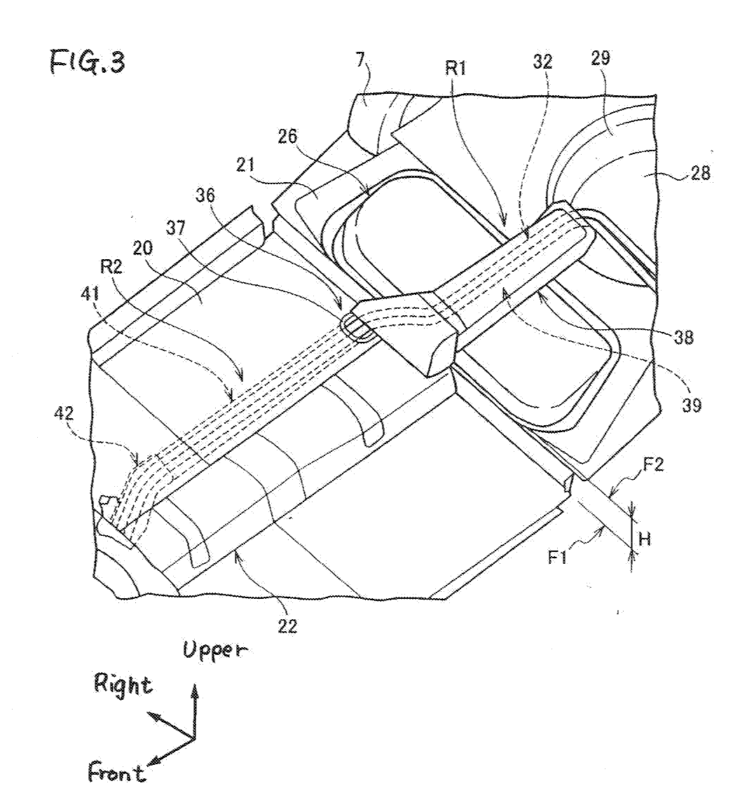

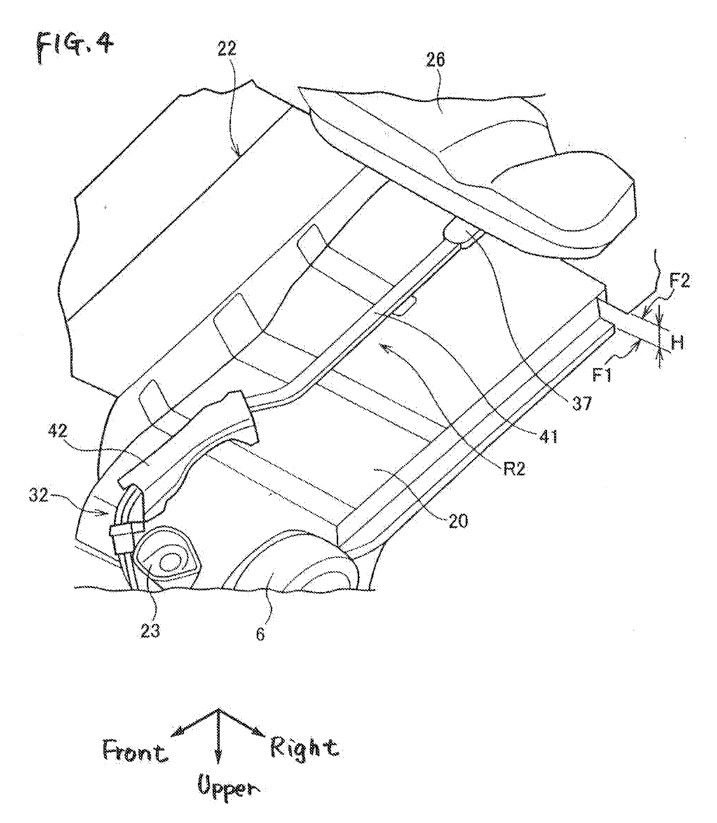

As illustrated in FIGS. 3 and 4, a height difference H between a standard surface F1 of the front floor panel 20 and a standard surface F2 of the rear floor panel 21 is set to a value similar to the height of fuel tank 26. The fuel tank 26 is supported and fixed to the rear floor panel 21 under the rear floor panel 21 and in front of a suspension system or axle shafts of the rear wheels.

The battery 25 is arranged on the vehicle rear side of the fuel tank 26 and over the rear floor panel 21.

The external shape of the fuel tank 26 is flat in the vertical direction and in the vehicle front/rear direction X. The fuel tank 26 is mounted so that its longitudinal direction coincides with the vehicle width direction Y. A volatile fuel which is in a liquid state at an ordinary temperature is stored in the fuel tank 26.

A seat 27 acting as a rear seat is attached across rear floor panel 21 over the fuel tank 26.

In the rear floor panel 21 on the vehicle rear side of the fuel tank 26, a housing 29 having an internal space 28 with a height similar to the height difference H between the standard surface F1 of the front floor panel 20 and the standard surface F2 of the rear floor panel 21 is formed at substantially the rear side of the axle shafts of the rear wheels.

A high voltage energy system 30 is mounted in the vehicle 1. In the high voltage energy system 30, the inverter 31 which is connected to the battery 25 and controls the drive motor 17 is arranged in an upper portion of the engine compartment 3. The inverter 31 is arranged so as to cover regions over both the generator 16 at the front side and the drive motor 17 at the rear side.

Since auxiliary equipment of an intake system is arranged over the engine 15, when mounting to the vehicle 1, all units are assembled together with the inverter 31 and the on-vehicle unit 12, and they are integratedly mounted to the vehicle 1.

A high voltage cable 32 extending generally toward the vehicle front portion as a whole and connected to the inverter 31 is connected at an edge portion of the battery 25. The high voltage energy system 30 includes the generator 16, drive motor 17, battery 25, inverter 31, and high voltage cable 32.

The high voltage cable 32 is covered with a protective tube and is used to connect mainly the battery 25 and the inverter 31. Therefore, an almost constant voltage DC current flows and electromagnetic influence is extremely small.

As illustrated in FIGS. 1 and 2, a part of the high voltage cable 32 is arranged in the area corresponding to the passenger compartment 4. In a region over the rear floor panel 21, after the cable 32 has extended from one end of the battery 25 to the front side, and is bent in the vehicle center direction along the circumference of the battery 25 and reaches a position near the center in the vehicle width direction Y, it is again extended toward the vehicle front side.

At a position near a region where the rear floor panel 21 stands up from the front floor panel 20, the high voltage cable 32 penetrates the front floor panel 20 from an upper direction toward a lower direction of the rear floor panel 21 and, further, is extended along the lower surface of the front floor panel 20 toward the vehicle front portion in the vehicle front/rear direction X.

That is, as illustrated in FIGS. 1 and 2, the high voltage cable 32 is arranged at a position over the rear floor panel 21 which vertically overlaps with the fuel tank 26 at a central portion thereof in the vehicle width direction Y so as to lie substantially along a front/rear center axis 1C of the vehicle 1. The high voltage cable 32 is arranged in such a manner that ahead of the position where the cable overlaps the fuel tank 26, the cable enters the area corresponding to the passenger compartment 4 from the standard surface F2 of the rear floor panel 21 (we shall call this the inside-car route: R1), and in front thereof, the cable passes through a region below the standard surface F1 of the floor panel 20 on the right side in the vehicle width direction Y of the front/rear center axis 1C of the vehicle 1.

At a lower surface of the floor panel 20 (we shall call this the outside-car route: R2), the high voltage cable 32 is extended at a position between each side frame 9 and the central tunnel 22 in the vehicle front/rear direction X so as to follow them. At a position where the floor panel 20 is coupled with the dash panel 11, as illustrated in FIGS. 3 and 4, after the high voltage cable 32 has partially entered an edge portion space of the central tunnel 22, it is extended along the surface of the dash panel 11 which faces a back surface of the gear casing 18. The subframe 19 is provided at a lower position of dash panel 11. This position also corresponds to a position where the rear mount of the engine generator unit 13 is arranged.

In an internal space of a front edge of the central tunnel 22 and in a space also including a space sandwiched by the subframe 19, the high voltage cable 32 is arranged so as to avoid any interference with a steering rack.

Further, the high voltage cable 32 is arranged so as to be distanced from the exhaust pipe 24 to the opposite side in the vehicle width direction Y, thereby avoiding thermal influence and any interference in the narrow limited space. At the same time, since the high voltage cable 32 is extended from a high position serving as an upper portion of the internal space of the central tunnel 22 toward the front side of the front surface of the dash panel 11, a length range sandwiched between the dash panel 11 and the on-vehicle unit 12 is reduced, thereby preventing the high voltage cable 32 from being sandwiched between both of the dash panel 11 and the on-vehicle unit 12 when the space between the dash panel 11 and the on-vehicle unit 12 is reduced as a result of deformation.

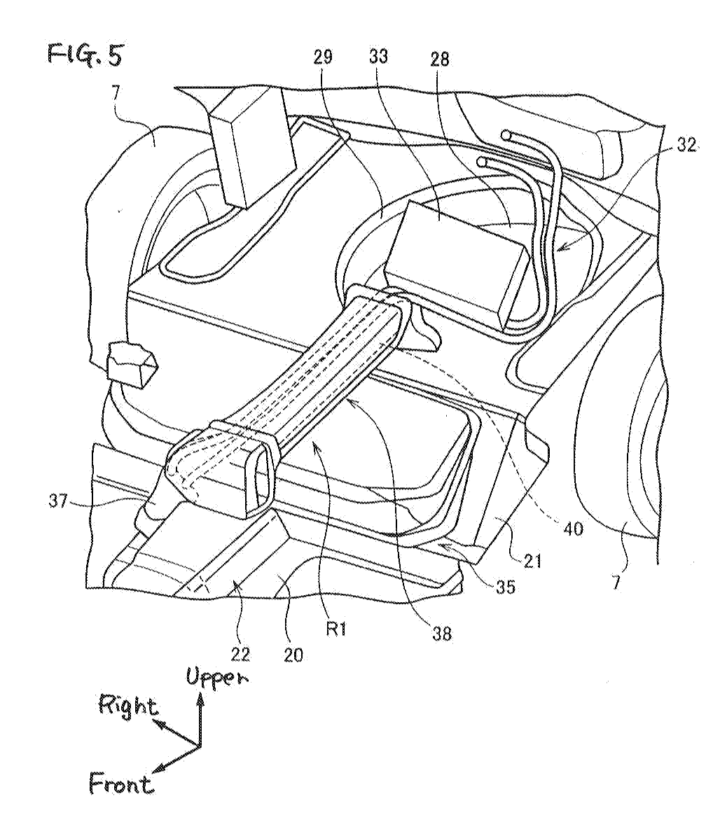

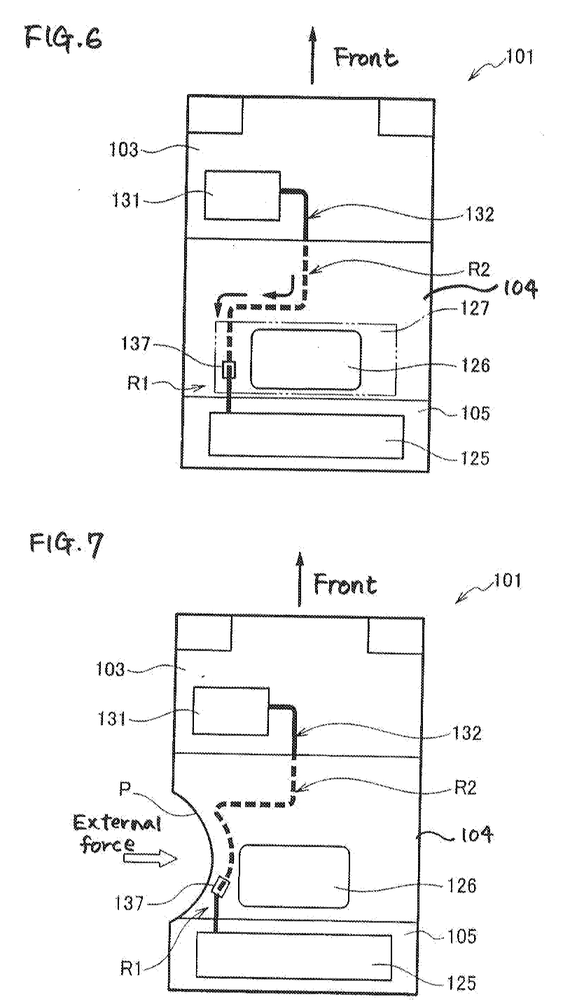

In the rear floor panel 21, as illustrated in FIG. 5, a charger 33 associated with the battery 25 is enclosed in the internal space 28 of the housing 29. An auxiliary frame including a cross member 34 is provided for the housing 29 and a structure creating an impedance to an external force from the rear or the side, thereby suppressing deformation is created.

When seen in plan view, after the high voltage cable 32 has extended from one end of the battery 25 to the front side, when it is bent in the vehicle center direction so as to lie along the circumference of the battery 25 and reaches a position near the center in the vehicle width direction Y, it is again extended toward the vehicle front side. The high voltage cable 32 in this portion enters the housing 29 having the internal space 28 in the vertical direction and is arranged so as to pass through the circumferential space of the charger 33.

At a position adjoining the position where the rear floor panel 21 stands up from the front floor panel 20, the high voltage cable on the rear side arranged over the rear floor panel 21 is arranged so as to become the high voltage cable 32 on the front side arranged under the front floor panel 20 and to enter the area corresponding to the passenger compartment 4, leaving the standard surface F2 of the rear floor panel 21. At this position, as illustrated in FIGS. 3 and 5, a rising portion 35 of the rear floor panel 21 is sandwiched between the front surface of the fuel tank 26 and the front floor panel 20.

A penetrating portion 36 where the high voltage cable 32 penetrates the front floor panel 20 is provided at a position where it avoids the central tunnel 22 of the front floor panel 20 and is slightly deviated in the vehicle width direction Y from the center line 1C of the vehicle 1.

As said, in a region over the rear floor panel 21, that is, in a portion extending to the front of the vehicle in the central area of the vehicle width direction Y, the high voltage cable 32 overlaps with the fuel tank 26 in the vertical direction so as to transverse in the front/rear direction.

As illustrated in FIG. 4, a grommet 37 is provided in the portion where the high voltage cable 32 penetrates the front floor panel 20.

The high voltage cable 32 of the inside-car route R1 at the grommet 37 and compartment 4 side is covered with a first cover member (a cover made of sheet metal) 38. The first cover member 38 covers: the area of penetration 36 for entry to the area corresponding to the passenger compartment 4 upon leaving the standard surface of the rear floor panel 21 on the layout path of high voltage cable 32; the rising portion 35 of the rear floor panel 21; and a floor portion 39 corresponding to the rear seat 27.

As illustrated in FIG. 5, a ventilation duct 40 for cooling air flow is provided in parallel with the high voltage cable 32 for controlling the temperature of charger 33.

The ventilation duct 40 is made of a resin. In a manner similar to the high voltage cable 32, in a region over the rear floor panel 21, that is, in a portion extending in the vehicle front side in the central area in the vehicle width direction Y, the ventilation duct 40 vertically overlaps with the fuel tank 26 so as to transverse in the front/rear direction.

The ventilation duct 40 is provided for passage of cooling air to the charger 33 the temperature of which rises when the charger 33 enclosed in the housing 29 having the internal space 28 is operated.

The first cover member 38 is bent so that its front edge portion lies along the rising portion 35 of the rear floor panel 21. An opening is formed in a front edge surface (vertical wall portion) of the rising portion 35, thereby enabling air in the area corresponding to the passenger compartment to be communicated to the inside of the ventilation duct 40.

On the other hand, the high voltage cable 32 has such a structure that it passes so as to be deviated from the opening and is not simply exposed to the area corresponding to the passenger compartment 4. With the above construction, although the high voltage cable 32 projects slightly so as to reduce space foot space under rear seat 27, it is set into such a range as to occupy an undercut space below the seat, thereby preventing a substantial influence from being exercised on comfort or the like. Although rigidity is inherently high owing to a circumferential frame structure of the surface of the floor 10 at the position corresponding to the rear seat 27, it can be further increased and deformation can be suppressed.

Since the high voltage cable 32, ventilation duct 40, and first cover member 38 are suitable for almost simultaneous mounting, the cover members can be integrated as common parts, their attaching positions can be also set to common positions, with advantages for manufacture.

In other words, the ventilation duct 40 for controlling the temperature of the charger 33 is provided in parallel with the high voltage cable 32. The high voltage cable 32 and the ventilation duct 40 are inserted and laid in the first cover member 38. Structure members (the cross member, a seat portion for a hinge, and the like) provided so as to be extended in the vehicle width direction Y in order to fix the seat are provided under the rear seat 27. The high voltage cable 32 and the ventilation duct 40 are arranged so as to be sandwiched between them.

At a position at the vehicle rear side of the fuel tank 26, the battery 25 is arranged over the rear floor panel 21 and substantially over the charger 33. The battery 25 is a battery pack made up in such a manner that battery trains which are supported by battery frames and are arranged in a flat shape in the vertical direction are stacked vertically, or may be a high voltage battery. The battery 25 is attached so that its longitudinal direction coincides with the vehicle width direction and can be enclosed in a range comprised between the pair of right and left side frames 9.

Equipment and a battery for auxiliary apparatus (low voltage battery) are arranged and attached at adjacent positions which face both edges in the longitudinal direction of the battery 25 by making use of a space between the battery and wheel housings.

A DC/DC converter is assembled to an upper portion of the battery 25. A crushable protective member is provided behind the battery 25 so as to cover its rear surface.

The battery 25 and the charger 33 have cooling fans for temperature control and also have a ventilation duct structure for controlling temperature which is used to introduce air at a low temperature such as inside air and to mainly cool a controller (circuit board) of each battery (unit cell) and charger 33.

The ventilation duct 40 which is arranged in the first cover member 38 may be replaced by a ventilation duct which is directly connected to the battery 25.

As illustrated in FIG. 4, in the outside-car route R2, the high voltage cable 32 is covered with a second cover member (protective cover) 41 attached to the lower surface of the front floor panel 20.

Further, a front portion of the outside-car route R2 of the high voltage cable 32 is covered with a third cover member (protective cover) 42, passes through a region near the steering wheel attaching portion 23, and is extended toward the vehicle front portion.

Thus, in the invention according to claim 1, the high voltage cable 32 is arranged at a position over the rear floor panel 21 which vertically overlaps with the fuel tank 26 at a central portion thereof in the vehicle width direction Y so as to lie substantially along the front/rear center axis 1C of the vehicle 1. The high voltage cable 32 is arranged in such a manner that ahead of the position where the cable overlaps the fuel tank 26, the cable enters the area corresponding to the passenger compartment 4 leaving the standard surface F2 of the rear floor panel 21, and in front thereof, the cable passes through a region below the standard surface F1 of the floor panel 20.

As a result, the high voltage cable 32 can be arranged at a position which is sufficiently away from the side and rear surfaces of the vehicle. As illustrated in FIG. 1, the possibility of the cable suffering from the influence of an external force and the resulting vehicle body deformation P can be considerably reduced. At the same time, the high voltage cable 32 can be isolated also from the fuel tank 26 and the possibility of secondary damage being caused can be also extremely reduced. Further, the length of high voltage cable 32 which is exposed to the outside under the floor panel 10 is decreased and direct damage brought about during ordinary running can be also reduced. That is, as illustrated in FIG. 1, the high voltage cable 32 enters the area corresponding to the passenger compartment 4 from the front side of the fuel tank 26 and when it is under the rear seat 27, the cable 32 is arranged vertically near the vehicle center.

Consequently, when an external force from the side does act, since damage to the high voltage cable 32 is avoided owing to the central layout and the cable 32 does not pass through the region adjacent to the side of the fuel tank 26, contact with the high voltage cable 32 can be reduced.

In the invention according to claim 2, the high voltage cable 32 is connected to the inverter 31 attached to the vehicle at a front portion thereof, the second cover member 41 for covering the portion in the area corresponding to the passenger compartment 4 of the high voltage cable 32 is provided, and the second cover member 41 covers: the penetrating portion 36 which enters the area corresponding to the passenger compartment 4 leaving the standard surface of the rear floor panel 21 on the layout of the high voltage cable; the rising portion 35 of the rear floor panel 21; and the floor portion 39 corresponding to the rear seat 27.

Thus, while maintaining occupation space and passenger comfort, the high voltage cable 32 is isolated and both the passengers and the high voltage cable 32 can be protected. Since direct current at almost constant voltage flows, electromagnetic influence on the inside of the passenger compartment 4 is also small.

Further, in the invention according to claim 3, the ventilation duct 40 for temperature control of charger 33 is provided in parallel with the high voltage cable 32. The high voltage cable 32 and the ventilation duct 40 are inserted and laid in the second cover member 41.

Thus, since the high voltage cable 32, ventilation duct 40, and cover member 41 can be constructed as common parts, not only the number of parts can be reduced but also they can be almost simultaneously mounted with convenience for manufacture.

In the embodiment described, under the rear seat, if the high voltage cable and the resin duct for cooling the charger are arranged centrally in parallel and the two parts of the high voltage cable and the ventilation duct are protected from the rear seat by a sheet metal cover, there is no need to respectively set the seat metal cover which covers the high voltage cable and the resin duct for cooling the charger. The number of parts can be reduced.

Additionally, by integrating the engine generator unit and the drive motor gear casing unit, these can be mounted so as to have a compact size. However, since the driving power is not propagated, it is not always necessary to mechanically couple them but the on-vehicle unit can be also made up by the drive motor and the gear casing.

In the layout structure of the high voltage cable according to the invention, a hybrid electric vehicle of the so-called series type has been illustrated as an example. However, if the casing of the drive motor for generating the propulsion of the vehicle and the gear casing made up by the reduction gear are arranged so as to be similarly mounted in the space ahead of the dash panel, the invention can be also applied to a purely electric vehicle, or to hybrid vehicles using other driving systems (parallel system, split system, and the like).

### LIST OF REFERENCE NUMERALS

1. Vehicle
2. Vehicle body
3. Engine compartment
4. Area corresponding to passenger compartment
5. Luggage compartment
10. Floor panel
11. Dash panel
12. On-vehicle unit
13. Engine generator unit
14. Drive motor gear casing unit
15. Engine
16. Generator
17. Drive motor
18. Gear casing
20. Front floor panel
21. Rear floor panel
22. Central tunnel
24. Exhaust pipe
25. Battery
26. Fuel tank
27. Rear seat
29. Housing
30. High voltage energy system
31. Inverter
32. High voltage cable
33. Charger
35. Rising portion
36. Penetrating portion
37. Grommet
38. First cover member
39. Floor portion corresponding to the rear seat
40. Ventilation duct
41. Second cover member
43. Third cover member

1. In a vehicle in which a battery and a fuel tank are mounted in a vehicle rear portion, said battery being arranged at a vehicle rear side of said fuel tank and over a rear floor panel, a layout structure, comprising:
a high voltage cable arranged so as to be connected to said battery and to be extended toward a vehicle front portion, wherein said high voltage cable is arranged at a position over the rear floor panel where it vertically overlaps with said fuel tank at a central portion thereof in a vehicle width direction so as to lie substantially along a front/rear center axis of the vehicle and is arranged in such a manner that ahead of the position where the cable overlaps said fuel tank, the cable enters an area corresponding to a passenger compartment leaving a standard surface of said rear floor panel, and in front thereof, the cable passes through a region below a standard surface of a front floor panel.

2. The layout structure according to claim 1, wherein said high voltage cable is coupled with an inverter attached at the vehicle front portion and is provided with a cover member for covering the passenger compartment side of said high voltage cable, said cover member covering a penetrating portion which enters said area corresponding to the passenger compartment leaving the standard surface of said rear floor panel in the layout of said high voltage cable, a rising portion of said floor panel, and a floor portion corresponding to a rear seat of said vehicle.

3. The layout structure according to claim 2, wherein said battery has a charger provided in association therewith, wherein a ventilation duct for temperature control of the charger is provided in parallel with said high voltage cable, and said high voltage cable and said ventilation duct are inserted and laid in said cover member.

4. The layout structure according to claim 1, wherein said battery has a charger provided in association therewith, wherein a ventilation duct for temperature control of the charger is provided in parallel with said high voltage cable, and said high voltage cable and said ventilation duct are inserted and laid in said cover member.
